(19) United States
(12) Patent Application Publication
(10) Pub. No.: US 2015/0286125 A1
(43) Pub. Date: Oct. 8, 2015

(54) HIGH-EFFICIENCY PROJECTION SCREEN

(71) Applicant: Microsoft Corporation, Redmond, WA (US)

(72) Inventor: Karlton David Powell, Lake Stevens, WA (US)

(73) Assignee: Microsoft Corporation, Redmond, WA (US)

(21) Appl. No.: 14/243,501

(22) Filed: Apr. 2, 2014

(51) Int. Cl. G03B 21/60

(52) U.S. Cl. CPC G03B 21/60

(57) ABSTRACT

Embodiments for a high-efficiency, high-uniformity projection screen are provided. In one example, a projection screen comprises an angle-dependent diffusing layer configured to transmit light non-diffusively within a first range of incident angles and transmit light diffusively within a second range of incident angles and a redirective element configured to receive light transmitted through the angle-dependent diffusing layer in one or more directions within the first range of incident angles and redirect the received light back through the angle-dependent diffusing layer in one or more directions within the second range of incident angles.

### SUMMARY

Embodiments related to high-efficiency, high-uniformity projection screens are disclosed. For example, in one disclosed embodiment, a projection screen comprises an angle-dependent diffusing layer configured to transmit light non-diffusively within a first range of incident angles and transmit light diffusively within a second range of incident angles, and a redirective element configured to receive light transmitted through the angle-dependent diffusing layer in one or more directions within the first range of incident angles and redirect the light received back through the angle-dependent diffusing layer in one or more directions within the second range of incident angles.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example projected image viewing environment.

FIG. 2 shows a cross-sectional view of an example projection screen.

FIG. 3 shows a cross-sectional view of another example projection screen.

FIG. 4 shows a schematic depiction of an example angle-dependent diffusing layer.

FIG. 5 shows a schematic depiction of another example angle-dependent diffusing layer.

FIG. 6 shows example paths of light through the example projection screen of FIG. 2.

FIG. 7 is a flow diagram illustrating a method for displaying a projected image with an example projection screen according to the disclosure.

FIGS. 8 and 9 show example outputs of first and second projection screens, wherein the outputs illustrate different amounts of overlap.

FIG. 10 shows a cross-sectional view of another example projection screen.

### DETAILED DESCRIPTION

Projection screens are configured to display images projected via a projector to one or more viewers. As such, projections screens commonly are configured to diffusely reflect projected light in a generally Lambertian intensity distribution so that projected images are viewable from a range of angles. High gain screens can attempt to diffusely reflect light within a reduced solid angle, to achieve a higher on-axis output, but may suffer from roll-off due to a bell curve distribution of the output angular profile, such that the luminance of the field of view differs substantially for viewing at different vantage points, and may further introduce non-uniformity across the FOV.

Projection screens that have a Lambertian response to projected light may reflect a significant quantity of light at relatively high angles. Such an intensity profile may offer the advantage of appearing somewhat flat in terms of uniformity over the field of view (FOV), as long as the viewer only sees a portion of the rolloff as the reflected light intensity decreases as a function of viewing angle. However, such screens may be too lossy in usage scenarios where most viewing takes place within a limited angular viewing range.

As light scattered at high angles beyond a typical viewing angle range may be considered wasted light, some screens may be designed to have higher gain. However, the roll off in intensity of such high gain screens as a function of view angle may result in non-uniformity across the FOV due to the exit profile of the scattered light mapping across some portion of the FOV. This effect may result in a screen appearing to be brighter near a center and rolling off near each edge. Further, this intensity ‘bubble’ may appear to follow viewer as the user changes vantage angle.

Thus, example projection screens are disclosed herein that may produce a flat-top reflected light intensity which is constrained within a limited angular exit width. By forcing a flat-top diffuse reflectivity, similar to how a homogenizer functions, an entire FOV may appear uniform as long as the viewer is viewing from within the eyebox formed by the diffuse envelopes emanating from each pixel of the screen. By redirecting light substantially within the designed exit eyebox, the screen becomes not only high-gain and highly efficient, but also may provide good uniformity across the FOV when viewed within the viewing eyebox.

To achieve such an effect, the disclosed projection screens may utilize a material having a refractive index which is a graded index (GRIN), or patterned index, as a diffusing/homogenizing layer. As explained in more detail below, the diffusion/homogenization provided by such a material may be angle-dependent, such that light at higher angles of incidence may pass through the diffusion/homogenization layer with little or no diffusion, while light at lower angles of incidence (relative to the normal angle of the projection screen) is homogenized and diffused. The term “solid angle of acceptance” may refer to the angular range of incident light that is homogenized and diffused.

With such a screen, a projector may be positioned to project light towards the projection screen at angles outside of the solid angle of acceptance of the diffuser/homogenization layer, and a redirective element incorporated into the screen may be configured to redirect this light back through the diffusing layer at an angle within the solid angle of acceptance, such that the light is diffused and homogenized. This may help to form a flat-top, sharp transition eyebox region that appears quite uniform in intensity across a FOV of the eyebox. As such, the projection screen may result in a relatively low amount of scatter into high viewing angles, and an amount of wasted light may be reduced. Further, an intensity of light reflected from the screen may be increased within the eyebox region compared to other projection screens. For example, a screen according to the present disclosure may result in twice the level of luminance compared to paper when viewed within the prescribed eyebox.

Such high-efficiency projection screens may be appropriate for a projection screen for multiple viewers within the prescribed eyebox, as described above. Further, such a high-efficiency screen configuration also may be used in personal projection screens, angle-dependent conspicuity applications, enhanced or angle-dependent viewing of printed content, and/or used to control the light reflected off printed devices, pads, and keyboards, for example.

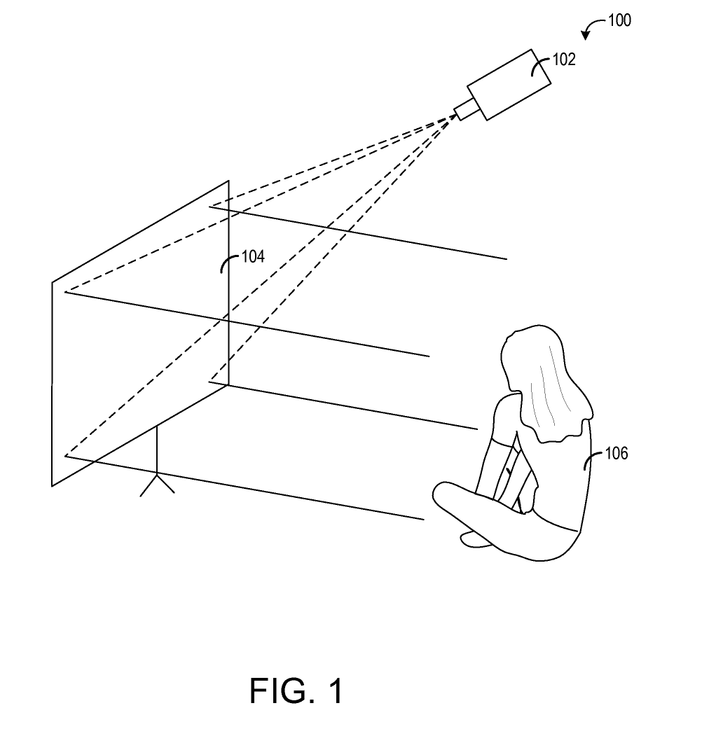

FIG. 1 illustrates an example projected image viewing environment 100. Environment 100 includes a projector 102 to project one or more images onto projection screen 104 for viewing by a viewer 106. Projector 102 may be a suitable projector, such as a digital projector configured to project images received from a video input signal, for example.

As mentioned above, projection screen 104 may be a high-efficiency, high-uniformity projection screen comprising a diffusion/homogenization layer, which also may be referred to herein as an angle-dependent diffuser layer. Projection screen 104 also may comprise a redirective element configured to redirect light from projector 102 toward viewer 106. Projector 102 may be positioned at an angle with respect to the normal of projection screen 104 such that light from the projector 102 is outside of the solid angle of acceptance of the angle-dependent diffuser layer. Further, the redirective element may be configured to redirect light received from the projector toward the viewer at an angle within the solid angle of acceptance of the angle diffusion layer. In this manner, light from the projector is not diffused and/or homogenized on its first pass through the angle-dependent diffuser layer, but is diffused/homogenized on its second pass through. This may help to achieve an acceptably uniform intensity of light across a desired range of viewing angles.

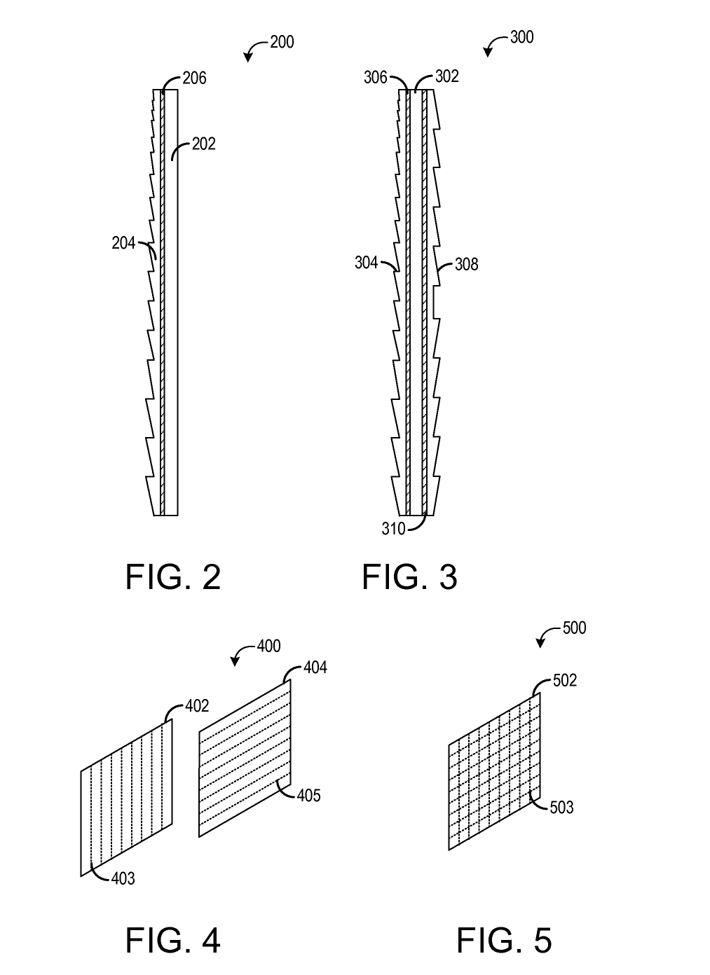

FIG. 2 shows a first example of a projection screen 200 suitable for use as projection screen 104. Projection screen 200 comprises an angle-dependent diffusing layer 202 and a redirective element 204. As shown in FIG. 2, angle-dependent diffusing layer 202 may be coupled to redirective element 204 via a transmissive layer 206. Transmissive layer 206 may be, for example, an adhesive layer, an air gap, or other suitable transmissive layer between angle-dependent diffusing layer 202 and redirective element 204. Further, in some examples, angle-dependent diffusing layer 202 may be directly coupled to redirective element 204 without an intermediate layer. Other mechanisms for coupling the angle-dependent diffusing layer to the redirective element may also be utilized, such as mechanical coupling elements (e.g., screws or other types of fasteners). Further still, the redirective element may be used as the substrate for the angle-dependent diffusing layer.

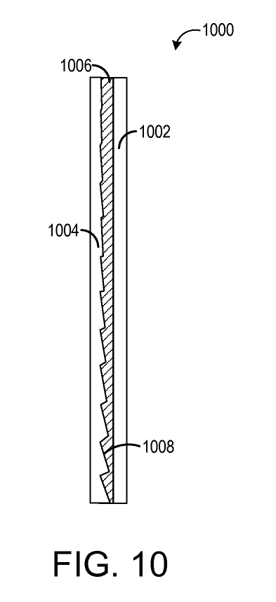

The redirective element may have any suitable configuration. For example, as illustrated in FIG. 10, a redirective element 1004 may be on the front surface of a support structure (e.g. a film substrate) with the Fresnel element of the redirective element 1004 flipped relative to the configuration illustrated in FIG. 2, such that a diffuser layer 1002 faces the Fresnelated surface instead of the flat side of the redirective element, as illustrated by projection screen 1000 of FIG. 10. A transmissive layer 1006, comprising an air gap or other media, may be present between the diffusing layer and Fresnel reflector. In some examples, for a given Fresnelated profile and pitch, the thickness of the profile of the redirective element 1004 may be smaller than the thickness of the redirective element 204 of FIG. 2, such as two-thirds the sag profile thickness, due to the difference in refractive index between air and bond or lamination media, as the redirection occurs in media rather than in air. One potential advantage of this configuration is that the Fresnelations may be protected when they are buried in the projector screen. However, the configuration of FIG. 2 may also have an additional layer on the Fresenalated surface to protect from it from handling or damage. In other examples, the redirective element may include a Fresnelated surface on a backside of the support structure and diffusing layer laminated or otherwise disposed on a flat front side. The diffusing layer may be laminated on this front side by optically clear adhesive, or directly used as the substrate for the diffusing layer. While the latter case may be more efficient for production, it is thought that the scatter seen with an air-gap in the screen may be reduced when moving toward a laminated approach.

In some examples when a reflective redirective element is utilized, a reflective layer, such as a metallization layer of aluminum or silver, or a dichroic thin film stack, may be applied to the Fresnelated surface, as indicated in FIG. 10 at 1008, to reflect and redirect the input light into acceptance of the angularly selective diffuser. The reflective layer or coating may be a partially-reflective broadband coating or a partially reflective wavelength selective coating, such as by use of a wavelength-selective dichroic thin film optical coating or wavelength-selective absorbing dyes. Further, the redirective element may be a Fresnelated surface having sufficiently small pitch so as to minimize artifacts due to spacing or aliasing with the projected input. Additionally, the redirective element may further comprise a holographic or ruled grating having appropriately arced grooves or rulings to place a diffraction order, such as the first order, or further a hologram which redirects a limited range of wavelengths, into the diffuser layer angle of acceptance. Color dispersion due to diffraction effects may be homogenized by the diffuser layer as long as the input is redirected into the diffuser acceptance angle for all wavelengths utilized by a given scenario.

As mentioned above, the angle-dependent diffusing layer 202 may be formed from a graded index, or patterned-index, diffuser that includes a periodically varying refractive index formed in one or more films. It will be understood that the term “periodically varying refractive index” signifies that the refractive index includes a plurality of alternating higher and lower index regions, and is not meant to imply any particular spacing between the regions, thus may have random spacing which could be considered to have an average spacing, or a correlation width. This randomization may help reduce possible coherent artifacts when using laser-based projectors. Such films may be made thick enough relative to average spacing of the refractive index grading, as well as the change in refractive index, as to induce a guiding effect similar to that achieved by fiber-optic faceplates for incident light within the solid angle of acceptance. However, in contrast to such fiber optic faceplates, which may be formed from hexagonally packed rods with cladding, one dimensional index gratings may be provided. Further, in some implementations, two crossed-layers of film each having a graded index profile across the grating dimension of the film may be utilized to achieve homogenization/diffusion in two dimensions, as described below with reference to FIG. 4.

A graded index film may be formed from any suitable material or materials. As a graded index layer may be considered to be a volume diffuse homogenizer, examples of suitable film materials include, but are not limited to, media comprising a mix of chemicals which dissociate or migrate upon exposure to ultraviolet (UV) light such that regions of high refractive index and regions of low refractive index are formed upon exposure, such as a LINTEC diffuser film (available from Lintec of America, Inc., Phoenix, Ariz.), or holographic film-based graded index diffusers formed by recording appropriate light intensity variation into holographic film, such as a BAYER holographic film (available from Bayer Material Science, LLP, of Pittsburgh, Pa.) or DUPONT HR film (available from the DuPont Corporation of Wilmington, Del.), to form a randomized array of high index and low index gratings within the volume of media to comprise the homogenizing diffuser in one or more holographic diffuser layers, and other films which may form structured refractive index such that the film has a low index and a high index and an average index within the layer to achieve a light guiding and diffusing function.

As mentioned above, in some examples an index grating of a graded index film may be one-dimensional (e.g. extend in one direction across a film), while in other embodiments the index grading may be two-dimensional. FIG. 4 shows an angle-dependent diffusing layer 400 (such as angle-dependent diffusing layer 202) comprising a first graded index film 402 and a second graded index film 404 to form a two-dimensional homogenizing/diffusing layer. First graded index film 402 includes a plurality of graded index elements 403 that traverse across first graded index film 402 along one dimension. Similarly, second graded index film 404 includes a plurality of graded index elements 405 that traverse across second graded index film 404 along one dimension. Second graded index film 404 may be positioned relative to first index film 402 such that graded index elements 405 are orthogonal to graded index elements 403. By crossing the two films orthogonally, the light guiding may be kept in a rectilinear fashion such that the output exit cone or solid angle of acceptance of the film is essentially rectilinear in shape, such as square, creating a rectangular solid angle, or pyramidal diffuse output.

The average index spacing between each graded index element of the graded index elements 403 and 405 may be equal on average across the length and/or width of the respective film, and may be a suitable average spacing, such as 3 μm. In other examples, the index spacing between each graded index element may vary across a width and/or length of the respective film. For example, the index spacing may decrease towards the center of the film. Further, the grating vector direction may vary across a width and/or length of the respective film. For example, the grating vector direction may be parallel to the diffuser film layer near center of the film, and may tilt in to or out of the diffuser film layer for positions away from center, as to enable a variation of the angular bias of output solid angle vs position across the film.

In other examples, an angle-dependent diffusing layer may comprise a rectilinear index cell comprising a single film graded along two dimensions to provide rectilinear output within a single layer, as illustrated in FIG. 5. In FIG. 5, an angle-dependent diffusing layer 500 (which may be another example of angle-dependent diffusing layer 202) comprises a graded index film having a plurality of rectilinear index cells 503. A single, rectilinear index cell film may be advantageous as an alternative when thickness is a high consideration, as each film may be on order of a 10-100 μm depending on film technology.

The use of a graded index film as an angle-dependent diffusing layer, as described in FIG. 4 or FIG. 5, may help to avoid limitations of volume and surface relief diffusers, where attempts to add scatter by multiple layers may serve to widen an angular output profile. Further, as mentioned above, angle-dependent diffusing layer 202 may be designed so as to include the effect of homogenization, which is associated with z-distance (e.g. thickness), as is the case with a microlens array-based homogenizer. By adjusting the thickness-to-grating-average-spacing aspect ratio, as well as index delta n between different refractive indices of the graded index film, to provide ample guided mixing of the input light, effective homogenization may be achieved along the thickness of the angle-dependent diffuser layer. The homogenization effect may be particularly advantageous for low to medium etendue scenarios, as it may be less possible to achieve such high levels of flat-top generation within a limited exit cone with standard diffusers without significant wasted light.

Returning to FIG. 2, redirective element 204 may comprise any suitable element that redirects incoming light that is outside of the solid angle of acceptance of the angle-dependent diffuser layer 202 (e.g., light projected from a projector) and redirects it at an angle within the solid angle of acceptance. For example, redirective element 204 may take the form of a Fresnel lens. In other examples, redirective element 204 may comprise other types of lenses. In other examples, redirective element 204 may comprise a transmissive or reflective optical grating, such as a first-order grating which may be used to reflect and redirect light, and further may include a grating profile which varies across position to provide variation in pointing of reflected light versus position. In some examples, the light redirected by redirective element 204 may be telecentric or collimated normal to the plane of the screen 200. In other examples, the light redirected by redirective element 204 may converge at a given distance from the screen. Redirective element 204 may be formed from any suitable material or materials, including but not limited to various glasses, plastics, acrylics, etc.

The combination of an angle-dependent diffuser layer 202 and radial Fresnel redirective element 204 may allow light to (1) transmit through the film at high angle of incidence with no or limited scatter, or scatter in one dimension, depending upon the configuration of the angle-dependent diffuser layer; (2) be redirected back toward the angle-dependent diffuser layer; (3) be homogenized by the angle-dependent diffuser layer; and (4) be diffused uniformly into the viewing eyebox.

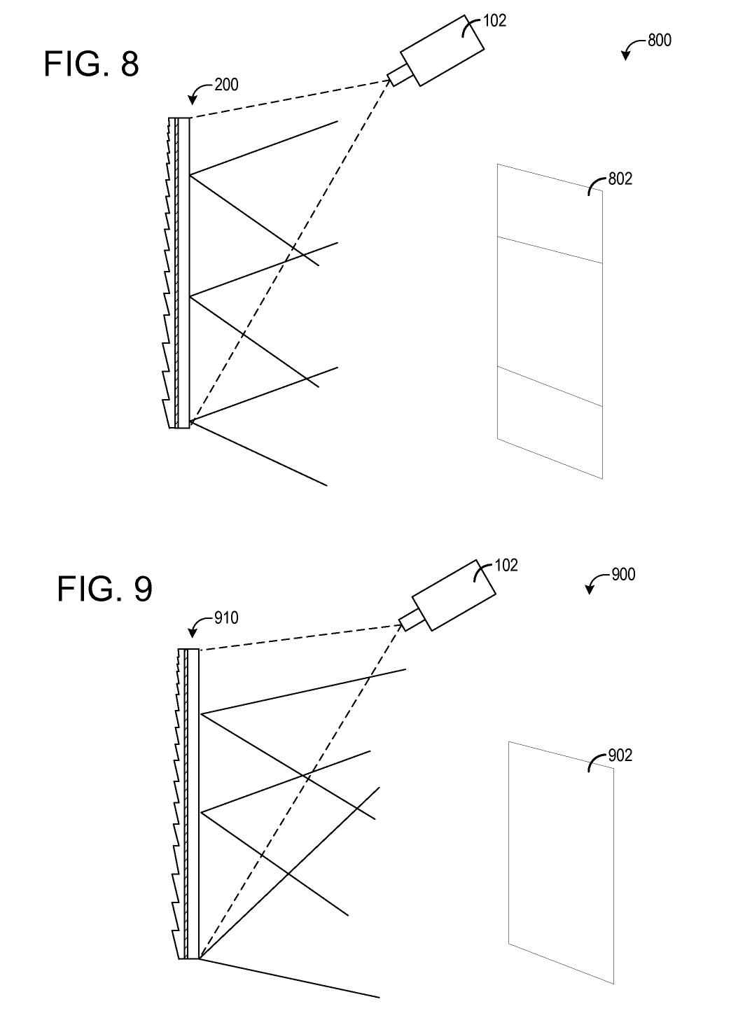

As mentioned above, when a graded index diffuser film which has constant index-grating character across the film is used, the desired redirected output from the Fresnel lens may be telecentric, or collimated normal to the screen plane. For example, as shown in FIG. 8, light from projector 102 is reflected from projection screen 200 at near-telecentric output. The light output creates overlapping eyeboxes 802.

However, if a Fresnel lens which converges input projected light to overlap at a prescribed z distance from the screen is used, the angle-dependent diffusing layer ideally may be further forced to fully overlap exit cones by making use of films having index gratings which vary in position across the film, in order to match exit cone center pointing to the redirection angle from the Fresnel lens, in order to further improve efficiency and sharpness of the overlapping eyebox. The graded index film may thus include a grading density that varies from an end of the film to a center of the film, or further may have a grating vector which varies in pointing angle from an end of the film to a center of the film. For example, as shown in FIG. 9, light from projector 102 is reflected from projection screen 910 to converge at a given distance from the screen. The light output creates a fully overlapping eyebox 902.

In another example, to further improve efficiency and sharpness of the overlapping eyebox, in addition or alternative to using an angle-dependent diffusing layer with a film or films that have varied index grading vector position across the film, a lens element, such as a weak Fresnel lens, may be coupled to the angle-dependent diffuser layer. FIG. 3 illustrates another example of a projection screen 300 that includes an angle-dependent diffusing layer 302 coupled to a redirective element 304 via a transmissive coupling layer 306. Angle-dependent diffusing layer 302, redirective element 304, and transmissive coupling layer 306 may be similar to angle-dependent diffusing layer 202, redirective element 204, and transmissive coupling layer 206 of FIG. 2. Further, projection screen 300 includes a lens element 308 coupled to angle-dependent diffusing layer 302 via a second transmissive coupling layer 310. By providing lens element 308, overlap of light transmitted towards the viewer from angle-dependent diffusing layer 302 may be made more fully overlapping.

In some examples, to increase the contrast of projection screen 200 or projection screen 300, RGB notch response filtering may be employed to absorb and/or reject undesired wavelengths of light (e.g., non-RGB light). The filtering may be designed to transmit a significant portion of the projector spectral output through the optical path of the projection screen, while rejecting or absorbing a significant portion of light outside the projector spectral output, such that ambient light is partially filtered out by the screen. For example, a rejection coating (e.g. a dichroic or rugate coating) and/or an absorbance coating (e.g. absorbing dye), may be applied to one or more elements of the projection screen. Examples of locations for such a coating or coatings include, but are not limited to, the front surface of the screen, on one or both sides of the angle-dependent diffuser layer, on the redirective element, etc.

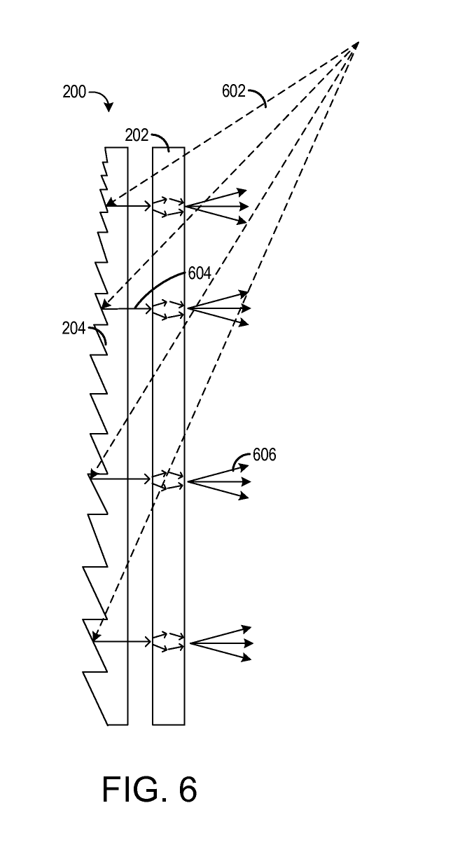

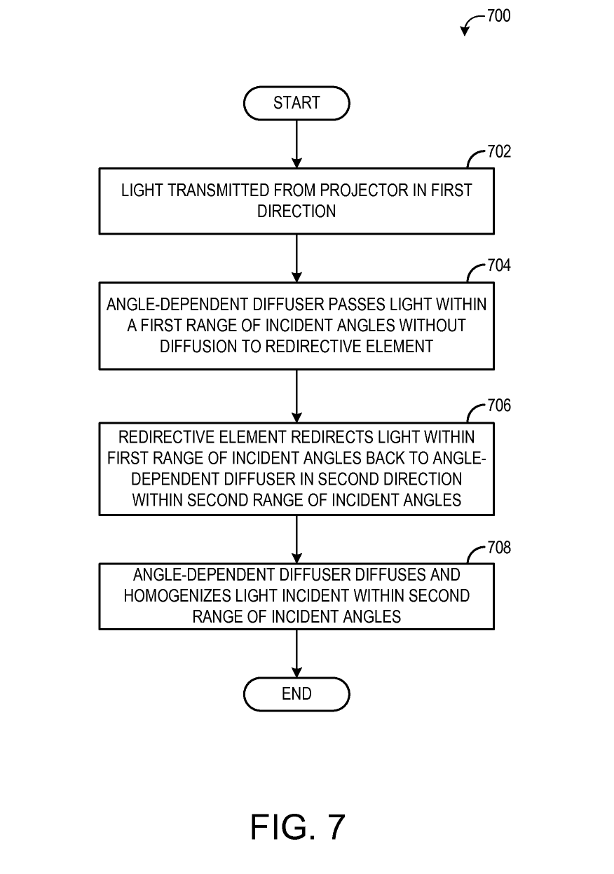

FIG. 6 illustrates example light paths through projection screen 200, and illustrates various processes shown in FIG. 7, which is a flow diagram illustrating a method 700 for displaying a projected image with an example projection screen, such as projection screen 200. At 702, light from a projector is incident on the projection screen in a first direction, as shown at 602 in FIG. 6. Light 602 may be incident at one or more angles within a first range of incident angles that is outside of the solid angle of acceptance of an angle-dependent diffusing layer, and as such will pass through angle-dependent diffusing layer with little or no diffusion, as indicated at 704. The light passed by the angle-dependent diffusing layer is then incident on the redirective element.

As indicated at 706, the redirective element redirects the light within the first range of incident angles back to the angle-dependent diffusing layer in a second direction or range of directions, wherein the second direction or range of directions is within the solid angle of acceptance of the angle-dependent diffuser layer.

As indicated at 708, the angle-dependent diffusing layer diffuses and homogenizes the light within the second range of incident angles. Referring to FIG. 6, light 604 redirected from redirective element 204 is homogenized and diffused into light 606 by angle-dependent diffusing layer 202. As explained previously, angle-dependent diffusing layer 202 comprises a plurality of high index cells each surrounded by a lower index boundary (e.g. formed from two layers of 1-dimensional index linear arrays or one layer of a two-dimensional square-cell array). This structure guides the light and causes effective homogenization and diffusion, providing a high consistency of luminance versus viewing angle within the desired eyebox.

While the above-described examples include a projection screen configured to display a projected image, an angle-dependent diffusing layer and redirective element as described herein may be used for other applications. For example, ink may be printed on an outer surface or inner surface of the angle-dependent diffuser layer, or on the redirective element, in a front-printed device such as an input pad or keyboard for controlled or forced light scenarios.

While the above-described examples include a projection screen with a reflective redirective element, in some examples the redirective element may be transmissive, and the projector or other light source may be transmitted to the transmissive redirective element and then homogenized and diffused by the angle-dependent diffuser layer In such scenario, the diffuser layer may not necessarily be angle dependent, but the homogenizing, flat-top output produced by the angle dependent diffuser layer may still be useful, and the diffuse layer could still be tailored versus position to form the overlapping eyebox. In such case, the projector source may be on-axis behind the screen or off-axis.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and sub-combinations of the various processes, systems and configurations, and other features, functions, acts, and/or properties disclosed herein, as well as any and all equivalents thereof.

1. A projector screen, comprising:
an angle-dependent diffusing layer configured to transmit light non-diffusively within a first range of incident angles and transmit light diffusively within a second range of incident angles; and
a redirective element configured to receive light transmitted through the angle-dependent diffusing layer in one or more directions within the first range of incident angles and redirect the received light back through the angle-dependent diffusing layer in one or more directions within the second range of incident angles.

2. The projector screen of claim 1, wherein the angle-dependent diffusing layer is configured to diffuse light in a rectilinear diffuse angular profile.

3. The projector screen of claim 1, wherein the angle-dependent diffusing layer comprises a graded index diffusing layer that is graded along two dimensions.

4. The projector screen of claim 3, wherein the graded index diffusing layer comprises a single film graded in two dimensions.

5. The projector screen of claim 3, wherein the graded index diffusing layer comprises a first film graded along one dimension and a second film graded along one dimension, wherein the first film is optically coupled to the second film and arranged orthogonally to the second film.

6. The projector screen of claim 1, wherein the redirective element comprises a Fresnel lens.

7. The projector screen of claim 1, wherein the angle-dependent diffusing layer is coupled to the redirective lens element via a substrate.

8. The projector screen of claim 1, wherein the redirective element is coupled to a first side of the angle-dependent diffuser, and further comprising a lens element coupled to a second side of the angle-dependent diffuser.

9. The projector screen of claim 1, further comprising one or more of a rejection coating and an absorbance coating.

10. The projector screen of claim 9, wherein the one or more of the rejection coating and absorbance coating is disposed on one or more of the redirective element and the angle-dependent diffuser.

11. A projector screen, comprising:
an angle-dependent diffusing layer configured to transmit light non-diffusively within a first range of incident angles and transmit light diffusively within a second range of incident angles, the angle-dependent diffusing layer graded along two dimensions; and
a redirective lens configured to receive light transmitted through the angle-dependent diffusing layer in one or more directions within the first range of incident angles and redirect the received light back through the angle-dependent diffusing layer in one or more directions within the second range of incident angles.

12. The projector screen of claim 11, wherein the angle-dependent diffusing layer comprises a single graded index film graded along two dimensions.

13. The projector screen of claim 11, wherein the angle-dependent diffusing layer comprises a first graded index film graded along one dimension and a second graded index film graded along one dimension, wherein the first film is arranged orthogonally to the second film.

14. The projector screen of claim 11, wherein the first range of incident angles is higher with respect to a screen normal than the second range of incident angles.

15. The projector screen of claim 11, wherein the redirective element comprises a reflective Fresnel lens.

16. A projector screen, comprising:
an angle-dependent diffusing layer configured to transmit light non-diffusively within a first range of incident angles and transmit light diffusively within a second range of incident angles with diffusion, the angle-dependent diffusing layer graded along two dimensions; and
a reflective Fresnel lens configured to receive light transmitted through the angle-dependent diffusing layer in one or more directions within the first range of incident angles and redirect the received light back through the angle-dependent diffusing layer in one or more directions within the second range of incident angles.

17. The projector screen of claim 16, wherein the angle-dependent diffusing layer comprises a graded index film including a grating vector direction that varies from an end of the film to a center of the film

18. The projector screen of claim 16, wherein the angle-dependent diffusing layer comprises a single graded index film graded along two dimensions.

19. The projector screen of claim 16, wherein the angle-dependent diffusing layer comprises a first graded index film graded along one dimension and a second graded index film graded along one dimension, wherein the first film is optically coupled to the second film and arranged orthogonally to the second film.

20. The projector screen of claim 16, wherein the Fresnel lens is coated with one or more of a rejection coating and an absorbance coating.
